(19) United States
(12) Patent Application Publication
(10) Pub. No.: US 2012/0169491 A1
(43) Pub. Date: Jul. 5, 2012

(54) RELAY NODE PLACEMENT METHOD IN WIRELESS BODY SENSOR NETWORK

(76) Inventors: Yi-Yin CHANG, Hsinchu (TW); Chung-Ta King, Hsinchu (TW); Chun-Yu Lin, Hsinchu (TW)

(21) Appl. No.: 13/076,126

(22) Filed: Mar. 30, 2011

(30) Foreign Application Priority Data
Dec. 29, 2010 (TW) 099146515

(51) Int. Cl. G08B 1/00

(52) U.S. Cl. 340/531

(57) ABSTRACT

The present invention provides a Relay Node Placement Method in Wireless Body Sensor Network. It provides a sensor data collection location and a plurality of sensor locations. Then based on those sensor locations and their corresponding time delays, a sensor location data group is generated, then based on the sensor location data group, a set cover problem is set up. Through an approximation algorithm, within linear time, the solution of that set cover problem is then solved so as to decide the minimal quantity of the first relay nodes of the trunk of human body; moreover, based on a given human body model, a plurality of second relay node candidate locations, those first relay node and the sensor data collection location, a minimal spanning tree problem is set up so as to decide a plurality of second relay node locations.

### FIELD OF THE INVENTION

The present invention relates to a method for deploying relay node on human body, and it specifically relates to Relay Node Placement Method applied in Wireless Body Sensor Network so as to increase the packet transmission success rate.

### BACKGROUND OF THE INVENTION

In recent years, along with the development in internet technology, the application scope of all kinds of wired and wireless network gets more wide-spreading, moreover, due to the convenience of the wireless communication. Currently, wireless network has gradually replaced wired network, for example, wireless local area network (LAN) and Wireless Body Sensor Network (WBSN), etc.

Among them, the development of Wireless Body Sensor Network (WBSN) has brought lots of human body monitoring applications; such technology mainly includes lots of sensors and a data processing center, which are generally used in detecting human body information and transmit, process and store it; it can be applied in home care, health care and other industrial services, for example, through WBSN and inertial sensors deployed on human body, information such as acceleration and angular acceleration can be collected and analyzed, then the human action can be recovered, and such technology is widely used in the development of new technology of human body motion capture; in the mean time, this technology can also be applied in medical electronic system, for example, the development of rehabilitation system.

### SUMMARY OF THE INVENTION

One objective of the present invention is to propose a Relay Node Placement Method for one Wireless Body Sensor Network.

According to the present invention, a Relay Node Placement Method for one Wireless Body Sensor Network comprises of the providing of a sensing data collection location and a plurality of sensing locations, then based on these sensing locations and the corresponding time stamps, a sensor location data group is generated, then based on the sensor location data group, a set cover problem is constructed, then through an approximation algorithm, the solution of the set cover problem is obtained within linear time so as to decide the minimal first relay node quantity on the trunk of human body; then, based on a given human body model, a plurality of second relay node candidate locations, those first relay nodes and the sensing data collection location, a minimal spanning tree problem is set up so as to decide a plurality of second relay node locations.

For the advantages and spirit regarding the present invention, further understanding can be achieved through the following detailed description and attached drawings of the present invention.

### BRIEF DESCRIPTION OF THE DRAWINGS

FIG. 1 is the system architecture drawing of Wireless Body Sensor Network proposed by this invention;

FIG. 2 is the three dimensional illustration of Wireless Body Sensor Network as proposed by this invention;

FIG. 3 is an illustration of sensor location data group of this invention; and

FIG. 4 is the correlation connection model figure on the trunk of human body based on this invention.

### DETAILED DESCRIPTION OF THE INVENTION

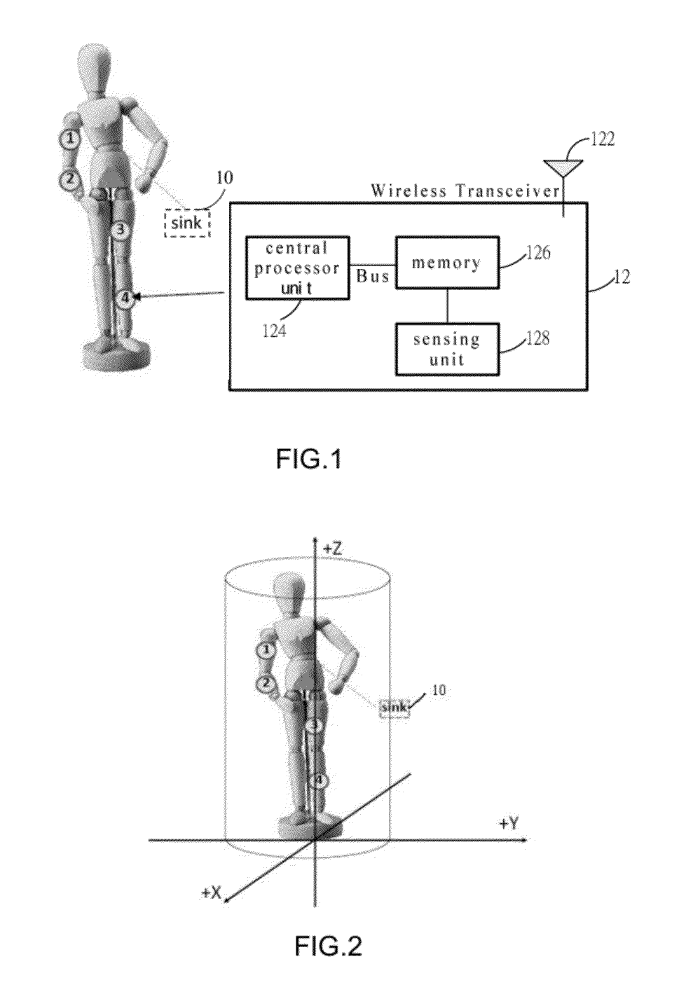

In rehabilitation exercise, the therapist will ask the patient to implement special exercise so as to train the injured and disabled limbs and body. FIG. 1 is the system architecture of Wireless Body Sensor Network as proposed by this invention, which mainly comprises of sensing data collector (Sink) 10 installed on the trunk and several sensors 12 installed on the limbs; to facilitate the explanation, in the subsequent figures, circles 1-4 will be used to represent the locations of all the sensors 12; the internal architecture of each sensor 12 is as shown in the right side of FIG. 1, which comprises of respectively central processor unit 124, memory 126, bus, wireless transmitter 122 and sensing unit 128, wherein, wireless transmitter 122 is represented by antenna. Sensing unit 128 can include environmental temperature, luminance, acceleration, direction or cardiogram and electromyography while the human body is moving. The data collected by sensing unit 128 is stored in memory 126, then after the collection and processing by central processor unit 124, it is sent to sensing data collector 10 through wireless transmitter 122. Sensing data collector 10 is in charge of collecting the sensing data, processing sensing data and send these sensing data to the remote data processing system, database or expert system.

Since wireless transmitter 122 on sensor 12 is limited by power and size, the transmission distance is smaller; moreover, the wireless signal can be reduced easily due to human body isolation, which leads to lower packet transmission success rate, hence, in this invention, a method for the deployment of relay node on Wireless Body Sensor Network for human body is proposed so as to connect sensor and sensing data collector and to increase packet transmission success rate.

In the initial stage, the user, through the interface system first, will select one of a plurality of action items that are deployed in advance in action database to be corresponded to rehabilitation action; those action items are generally stored in digital format, for example, BVH file. The digital format action items generally store (1) Time-sharing location of the trunk (2) Time-sharing location of the limbs, or other representation methods that can be converted into these two information. After one action item is selected, the system architecture of FIG. 1 can be used to collect the information needed for the implementation of Relay Node Placement Method of Wireless Body Sensor Network of this invention.

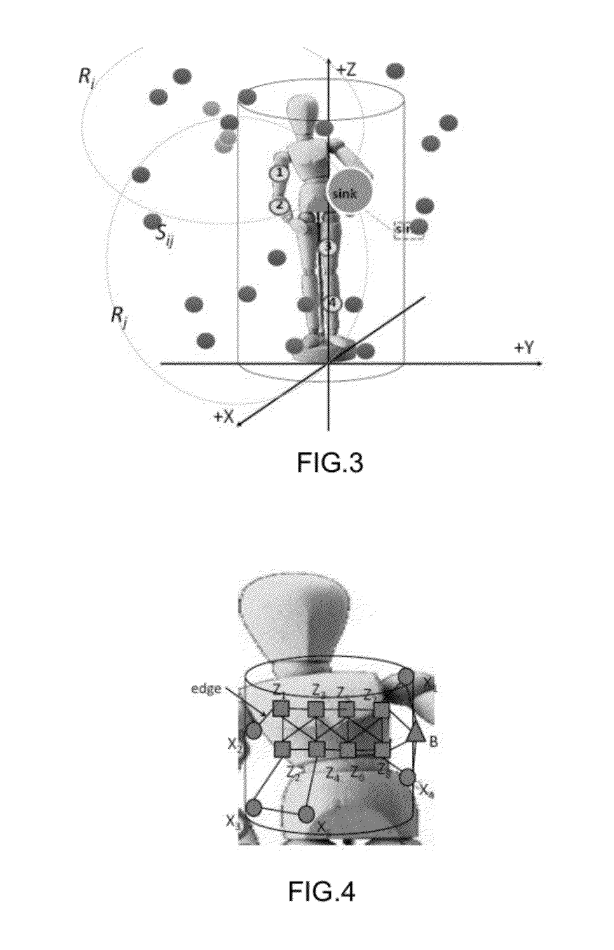

Since all the sensors are tied to the body and limb and trunk and move around with them, hence, the time-sharing location of trunk and limbs can similarly be used to calculate the time-sharing locations of sensors. In FIG. 2, three dimensional coordinate is used to represent the relationship between the location of sensor 12 and the location of sensing data collector 10; the person under test will move in the 3D space of the peripheral of human body as in FIG. 2, that is, the centerline of human body will be used as center, the front side is the positive X axis, the left side is the positive Y axis, and positive Z axis is the direction axis from the bottom of the foot to the head. In the 3D space as represented in FIG. 2, the trunk of human body is represented as a cylindrical boy with centerline the same as the 3D space; the location at different time for each sensor 12 represents a data point in this space, hence, we can obtain a set of sensor location data group (instances) comprises of sensor ID(1-4), location coordinate and timestamp, which is represented by <sensor ID, location (x, y, z), timestamp>. Please refer to FIG. 3. In other words, the location points within the group are the locations that all the sensors will appear during the moving process of the person under test. Through the above mentioned parameter setup, this invention has proposed an algorithm to put transmission relay nodes on the trunk so that when the sensors move to any expected locations, the data can, through the deployed relay nodes, be transmitted back to the sensing data collector 10.

Relay Node Placement Method proposed by this invention can be divided into two steps. In the first step, the goal is to deploy the minimal number of relay nodes on the trunk of human body, hence, each action sensor at each time point will be covered by at least one relay node. In the second stage, we have added on the trunk additionally the minimal number of relay nodes, hence, the relay node and receiver deployed in the first stage in backbone will form a connected network so as to help all the action sensors to send the data to the receiver. In the following, detailed description for each stage will be carried out.

### First Stage

This invention constructs the relay node deployment method in the first stage as a set cover problem. Since the area of human body is limited, relay node can only be placed on limited location, first, there are n locations that can be placed with relay nodes, then let Rₖ represents a set of sensor data group, wherein all the sensor locations within Rₖ can be placed at k^{th} location relay node sensor for reception and are not isolated by human body. Let S represent all the sensor location data groups, the followings are then the normalized definitions:

S={S₁₁,S₁₂, . . . ,Sᵢⱼ, . . . ,Sₘₜ} wherein i=[1,m], j=[1,t] (1)

R={R₁,R₂, . . . ,Rₖ, . . . ,Rₙ} wherein k=[1,n] (2)

According to the above definitions, this step will select from R the minimal sensor data group R′ so that all S will be included in R′.

Set cover problem currently has been proved as an algorithm issue that can not be completed with calculation within linear time, hence, in this invention, approximation algorithm is used to find solution within linear time. The following algorithm is one possible solution for the issues illustrated in this invention, the solution finding through other approximation method aiming at set cover problem is predictable, which should belong to the scope of this invention.

The solution finding steps in this stage can be represented by the following operation steps, accompanied with text description, it includes:

Greedy-Set-Cover(S, R)

1. U←S//Put the sensor location data within S into U set;
2. C←φ//Let C be an empty set, C represents the sensor location data that can be covered already;
3. K←φ//It represents the set of relay node location number that is selected;
4. While U≠φ//When U is not empty set;
5. select RₖεR that maximizes |Rₖ∩U|. //From the selected R, Rₖ is selected, and the number of sensor location data of intersection of Rₖ and U is maximum;
6. U←U−Rₖ//Remove the sensor location data of selected Rₖ away from U set;
7. C←C∪Rₖ//Add the sensor location data of selected Rₖ into C set;
8. K←K∪k//Add the relay node location k into K set;
9. endwhile;
10. return K//Send back the final K set.

Next, enter the second stage, additional relay nodes are deployed to connect the relay nodes on the trunk with the data collector:

As mentioned above, after the decision of those relay nodes in the first stage, in the second stage, a plurality of second relay nodes will be decided so as to connect all the relay nodes to sensing data collector 10. In the current invention, the deployment method at the second stage is corresponded to one minimal spanning tree problem. First, let the first relay node decided at the first stage be X, and the second relay node candidate location of the second stage as Z, and the sensing data collector location as B. Take a look on the node within X, whether it can be, through wireless transmission, connected to other X nodes, candidate nodes within Z, or B, will be dependent on a given human body model H, and this is to represent its connection situation, hence, based on this, the correlation connection model HCG(H, B, X, Z) as in FIG. 4 is set up. The edge in the connection model is assigned with a weighting, and the decision way of weighting is the quantity of Z, X, or B within two end points, in other words, the weighting of an edge is {0, 1, 2}. Based on this correlation connection chart, relay nodes are selected from Z, meanwhile, between all the nodes within X and B, there will be spanning tree connection route on the correlation chart, the sum of weighting of the route will also be the minimum among all the routes. The route is called feasible connected relay node placement (F-RNP). The following is the relay node decision algorithm:

### Approximation for RNPc (H, B, X, Z)

Input: Input: H, set of BSs B, set of SNs X, set of candidate locations of RNs Z//In given human body model H, the location of sensing data collector is B, the relay node decided in the first stage is X, relay node candidate location is Z.
Output: Output: An F-RNPc for (H, B, X, Z) given by Y_{A}⊂Z.//It decides a feasible connected relay node placement method.
The steps include:
1: Construct HCG (H, B, X, Z).//Set up correlation connection model;
2: Assignedge weights to the edges in HCG (H, B, X, Z) as in Definition 2//Decide the weighting of edge in HCG;
3: Apply Prim's algorithm to compute a minimum spanning tree subgraph T_{A} of HCG(r, R, B, X, Z) which connects all nodes in BuX.//Take HCG as basis to implement minimal spanning tree algorithm, then select edge in HCG to generate a spanning tree T_{A} so that all the data in B and X set can be connected together;
4: Output Y_{A}=Z∩V(T_{A})//In relay node candidate location Z, the node intersection with spanning tree T_{A} is then the final feasible connected relay node placement method.

As mentioned above, the Relay Node Placement Method proposed by this invention, through the above mentioned given parameters, will generate a plurality of first relay node locations after the first stage algorithm, then through the second stage algorithm, a plurality of second relay node locations are then decided, and the relay node deployment is then completed.

Although the present invention is disclosed through a better embodiment as above, yet it is not used to limit the present invention, anyone that is familiar with this art, without deviating the spirit and scope of the present invention, can make any kinds of change, revision and finishing; therefore, the protection scope of the present invention should be based on the scope as defined by the following attached “what is claimed”.

What is claimed is:

1. Relay Node Placement Method of a Wireless Body Sensor Network, comprising of the following steps:
providing a sensing data collection location and a plurality of sensing location;
generating a sensor location data group according to these sensing locations and the corresponding timestamps;
constructing a set cover problem according to sensor location data group;
obtaining the solution for the set cover problem through an approximation algorithm and within linear time so as to decide the minimal first relay node number on the trunk of human body; and
constructing a minimal spanning tree problem based on given human body model, a plurality of second relay node candidate location, those first relay nodes and the sensing data collection location so as to decide a plurality of second relay node location.

2. The method of claim 1 wherein the steps of constructing minimal spanning tree problem based on those first relay nodes and the data collection location so as to decide a plurality of second relay node location include:
constructing a correlation connection model according to those first relay node and the sensing data collection location;
deciding the weighting of each edge in the correlation connection model;
implementing minimal spanning tree algorithm and selecting those edges to generate a spanning tree based on the correlation connection model so that the sensing data collection location and all the data points in the first relay node set are connected together; and
selecting from those second relay node candidate locations the intersection with the nodes of spanning tree so as to decide the placement locations of those second relay nodes.
